(19) United States
(12) Patent Application Publication
(10) Pub. No.: US 2017/0318344 A9
(43) Pub. Date: Nov. 2, 2017

(54) Ranking User Search and Recommendation Results for Multimedia Assets Using Metadata Analysis

(71) Applicant: Tivo Solutions Inc., San Carlos, CA (US)

(72) Inventors: Matthew Berry, Raleigh, NC (US); Aaron Bickell, Durham, NC (US); Adam Gordon, Raleigh, NC (US)

(21) Appl. No.: 13/757,778

(22) Filed: Feb. 2, 2013

Related U.S. Application Data
(60) Provisional application No. 61/593,995, filed on Feb. 2, 2012.

(51) Int. Cl. H04N 21/466; G06Q 30/06; H04N 21/482; H04N 21/84

(52) U.S. Cl. CPC H04N 21/4668; H04N 21/84; G06Q 30/0631; H04N 21/4826

(57) ABSTRACT

Methods and system for presenting a user with multimedia digital content available to and having a high correlation of potential viewing interest to the user, comprises determining which multimedia assets are available to the user; ranking the available multimedia assets as a correlation between the user's interests and demographic information and metadata associated with each multimedia asset. Higher ranking and relevance of each respective multimedia asset is indicative of a higher likelihood of viewing interest to the user. The ranked and available multimedia assets are presented to the user on an interactive display screen, where the higher ranked multimedia assets are featured more prominently to the user on the interactive display screen. The user is then able to take further action with respect to each presented multimedia asset.

### CROSS REFERENCE TO RELATED APPLICATION

This application claims the benefit under 35 U.S.C. §119(e) of U.S. Provisional Patent Application No. 61/593,995, entitled “Ranking User Search and Recommendation Results,” filed Feb. 2, 2012, which is incorporated herein by reference in its entirety.

### FIELD OF THE PRESENT INVENTION

The present inventions relate generally to the navigation and searching of metadata associated with digital media. More particularly, the present systems and methods provide a computer-implemented system and user interface to make it efficient and easy to navigate, search for, and identify highly relevant multimedia digital assets of potential interest to a system user based on information and interests of the system user, which is cross-referenced to metadata associated with each digital media asset from a collection of digital assets available to the system user.

### BACKGROUND OF THE PRESENT INVENTION

The Internet has made various forms of content available to users across the world. For example, consumers access the Internet to view articles, research topics of interest, watch videos, and the like. Online viewing of multimedia or digital media has become extremely popular in recent years. This has led to the emergence of new applications related to navigating, searching, retrieving, and manipulating online multimedia or digital media and, in particular, videos, such as movies, TV shows, and the like. Although users sometimes just want to browse through broad categories of videos; more often, users are interested in finding very specific videos to view based upon mood or desire at the time they wish to view a video. Additionally, with the proliferation of video content sources, navigating even those video programs being offered at particular times can be a daunting task for any user.

The growing prominence and value of digital media, including the libraries of full-featured films, digital shorts, television series and programs, news programs, and similar professionally (and amateur) made multimedia (previously and hereinafter referred to generally as “videos” or “digital media” or “digital media assets or files or content”), requires an effective and convenient manner of navigating, searching, and retrieving such digital media as well as any related or underlying metadata for a wide variety of purposes and uses.

“Metadata,” which is a term that has been used above and will be used herein, is merely information about other information—in this case, information about the digital media, as a whole, or associated with particular images, scenes, dialogue, or other subparts of the digital media. For example, metadata can identify the following types of information or characteristics associated with the digital media, including but not limited to actors appearing, characters appearing, dialog, subject matter, genre, objects appearing in a scene, setting, location of a scene, themes presented, or legal clearance to third party copyrighted material appearing in a respective digital media asset. Metadata (i) may be related to the entire digital media asset (such as the title, date of creation, director, producer, production studio, etc.), (ii) may present more macro-level descriptive information (such as plot points, scene descriptions, content commentary, and the like), or may only be relevant to particular scenes, images, audio, or other portions of the digital media.

Additionally, metadata may be used to provide the basis for derived conditions, such as recommended video content for a user or a group of users. Such derived conditions may also include the time and source of recommended content to provide sorting capabilities for content discovered during a search request initiated by a system user for video to be viewed or recorded.

Preferably, an effective and convenient manner of navigating, searching, and retrieving desired digital media through the effective use of metadata, and preferably several hierarchical levels or layers of metadata, associated with digital media, particularly when such metadata can be tied closely to specific and relevant points in time, ranges of time within the digital media asset, or desired user content for viewing, can provide significant value and is a much needed capability in the entertainment and advertising industries, to mention just a few.

The present inventions, as described and shown in greater detail hereinafter, address and teach one or more of the above-referenced capabilities, needs, and features that would be useful for a variety of businesses and industries as described, taught, and suggested herein in greater detail.

### SUMMARY OF THE PRESENT INVENTION

The present inventions relate generally to the navigation and searching of metadata associated with digital media. More particularly, the present systems and methods provide a computer-implemented system and user interface to make it efficient and easy to navigate, search for, and identify highly relevant multimedia digital assets of potential interest to a system user based on information and interests of the system user, which is cross-referenced to metadata associated with each digital media asset from a collection of digital assets available to the system user.

The system disclosed herein uses asset-based and time-based metadata associated with digital media to determine content that is closest to a system user's requested content. The function may be based upon a user ID, or may be performed as an anonymous function call not using any particular or established user ID. The initial matching of titles is performed as a semantic search through the use of asset-based and time-based metadata associated with content accessible to the system. Ratings data, including ratings data developed by a proprietary rating and recommendation engine, as well as other ratings data from commercial and social network recommendation sites may be blended with the information retrieval search results until a pre-determined numerical blend of the search results and ratings data is achieved. Upon reaching the pre-determined numerical blend of search results and ratings data, the optimum point for reporting discovered video content to a system user has been achieved. Recommended content as identified by the content item similarity based upon relevancy to a user or group of users or a predicted rating as to the desirability of the discovered content based upon scoring from past viewing selections is reported to the system user.

The video content or digital media assets discovered from all sources to which the user, or users, has access is sorted based upon the relevancy or the predicted rating, and the time slot of when the video content is available. The results of the discovered video content may be further filtered through user interaction to restrict or present the discovered video content on the basis of filter parameters such as the genre, rating, or time period of the assets in the discovered video content. The discovered, and optionally further filtered, video content, as a selection of video assets available for selection, is presented to the user or group of users in a sorted, ranked order populating a user display screen with all video assets for each particular time slot. The user or group of users may then select a video asset for a particular action or function, where the action or function may include immediate viewing, later viewing, recording, purchasing, renting, adding the asset to a list of favorites, and/or communicating the user's interest in the digital asset to others via text, email, or postings to social media sites, and the like. Such actions or functions are preferably presented as a list of options available to the user. A user-scheduling bar is presented to the user that displays the time slot, selected asset, chosen action or function for the asset, and recording selection status for those assets to be recorded. The user-scheduling bar is interactive and updates in response to user selections from the video assets displayed in the screen for each time slot. The discovered content may also include assets that are not currently available to that user or group of users, but may become available if the user upgrades their content subscription.

In a first aspect, a method for presenting a user with multimedia digital content available to and having a high correlation of potential viewing interest to the user, comprises collecting metadata associated with the user, the user metadata identifying demographic information about the user and multimedia viewing interests of the user; identifying a collection of multimedia digital content, where each multimedia asset in the collection of multimedia digital content has metadata associated therewith that identifies information about the multimedia asset; in response to a request from the user for access to the collection of multimedia digital content: determining which of the multimedia assets in the collection of multimedia digital content is available to the user; ranking the available multimedia assets as a function of the user metadata and of the multimedia asset metadata, where higher ranking of each respective multimedia asset is indicative of a higher likelihood of viewing interest to the user; presenting the ranked and available multimedia assets to the user on an interactive display screen, where the higher ranked multimedia assets are featured more prominently to the user on the interactive display screen; enabling the user to select one of the ranked and available multimedia assets, and thereafter enabling the user to take an action on the selected one of the ranked and available multimedia assets, where the action includes one or more of: (i) viewing the multimedia asset metadata associated with the selected asset, (ii) playing the selected asset on the display screen, and (iii) recording the selected asset for later access.

In features of the first aspect, the demographic information about the user includes one or more of: the user's age, sex, race, income status, education level, and occupation. In another feature, the multimedia viewing interests of the user are selected by the user from one or more lists of types of multimedia assets. In yet another feature, the multimedia viewing interests of the user are selected by the user from one or more lists of multimedia asset metadata. In other features, the multimedia viewing interests of the user are determined from ranked and available multimedia assets previously selected by the user. In another feature, the multimedia viewing interests of the user are determined from the multimedia asset metadata of the ranked and available multimedia assets previously selected by the user. Preferably, the multimedia asset metadata includes one or more of the following associated with the respective multimedia asset: title, date of creation, date of release, director, producer, production studio, awards given, awards nominated, actors appearing, characters appearing, dialog, subject matter, genre, objects appearing, settings, locations, themes presented, content ratings, critic reviews, user reviews, legal clearance to third party copyrighted material appearing therein, plot points, and content commentary. In a further feature, determining which of the multimedia assets in the collection of multimedia digital content is available to the user is based on content available to the public or based on subscription by the user. Further, determining which of the multimedia assets in the collection of multimedia digital content is available to the user may be based on time and date in which the content is available. In a related feature, the ranked and available multimedia assets presented to the user on the interactive display screen is organized by viewing schedule. In yet a further feature, the user is able to filter the request for access to the collection of multimedia digital content based on the multimedia asset metadata.

Second and third aspects of the present inventions include systems and a processor and a computer program product that includes a computer-readable medium that is usable by the processor, where the medium has stored thereon a sequence of instructions that when executed by the processor causes the execution of the steps of the method described with regard to the first aspect.

Embodiments of the invention can be implemented in digital electronic circuitry, or in computer hardware, firmware, software, or in combinations of one or more of the above. The invention, systems, and methods described herein may be implemented as a computer program product, i.e., a computer program tangibly embodied in an information carrier, e.g., in a machine-readable storage device or in a propagated signal, for execution by, or to control the operation of, data processing apparatuses, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps described herein can be performed by one or more programmable processors executing a computer program to perform functions or process steps or provide features described herein by operating on input data and generating output. Method steps can also be performed or implemented, in association with the disclosed systems, methods, and/or processes, in, as, or as part of special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are at least one processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with an end user, the invention can be implemented on a computer or computing device having a display, e.g., a cathode ray tube (CRT) or liquid crystal display (LCD) monitor or comparable graphical user interface, for displaying information to the user, and a keyboard and/or a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The inventions can be implemented in computing systems that include a back-end component, e.g., a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network, whether wired or wireless. Examples of communication networks include a local area network (LAN) and a wide area network (WAN), e.g., the Internet, Intranet using any available communication means, e.g., Ethernet, Bluetooth, etc.

The computing system can include clients and servers. A client and server are generally remote from each other and typically interact through a communication network. The relationship of client and server arises by virtue of computer programs running on the respective computers and having a client-server relationship to each other.

The present invention also encompasses computer-readable medium having computer-executable instructions for performing methods, steps, or processes of the present invention, and computer networks and other systems that implement the methods, steps, or processes of the present invention.

The above features as well as additional features and aspects of the present invention are disclosed herein and will become apparent from the following description of preferred embodiments of the present invention.

This summary is provided to introduce a selection of aspects and concepts in a simplified form that are further described below in the detailed description. This summary is not necessarily intended to identify all key or essential features of the claimed subject matter, nor is it intended to be used to limit the scope of the claimed subject matter.

### DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In addition, further features and benefits of the present inventions will be apparent from a detailed description of preferred embodiments thereof taken in conjunction with the following drawings, wherein similar elements are referred to with similar reference numbers, and wherein:

FIG. 1 presents an exemplary schematic view of the discovered video content and the user scheduling bar user display consistent with an embodiment of the invention;

FIG. 2 presents an exemplary schematic view of the quick filter selection display consistent with an embodiment of the invention;

FIG. 3 presents an exemplary schematic view of the detailed information screen for a selected video asset consistent with an embodiment of the invention;

FIG. 4 presents an exemplary screen shot for the primary user display screen consistent with an embodiment of the invention and corresponding to the schematic view of FIG. 1;

FIG. 5 presents an exemplary screen shot for the user filter search selection display screen consistent with an embodiment of the invention and corresponding to the schematic view of FIG. 2;

FIG. 6 presents an exemplary screen shot for the video asset detailed information display screen consistent with an embodiment of the invention and corresponding to the schematic view of FIG. 3; and

FIG. 7 presents an exemplary flow diagram for digital media content processing consistent with an embodiment of the inventions described herein.

### DESCRIPTION OF PREFERRED EMBODIMENTS

Before the present methods and systems are disclosed and described in greater detail hereinafter, it is to be understood that the methods and systems are not limited to specific methods, specific components, or particular implementations. It is also to be understood that the terminology used herein is for the purpose of describing particular aspects and embodiments only and is not intended to be limiting.

As used in the specification and the appended claims, the singular forms “a,” “an” and “the” include plural referents unless the context clearly dictates otherwise. Similarly, “optional” or “optionally” means that the subsequently described event or circumstance may or may not occur, and the description includes instances in which the event or circumstance occurs and instances where it does not.

Throughout the description and claims of this specification, the word “comprise” and variations of the word, such as “comprising” and “comprises,” mean “including but not limited to,” and is not intended to exclude, for example, other components, integers, elements, features, or steps. “Exemplary” means “an example of” and is not necessarily intended to convey an indication of preferred or ideal embodiments. “Such as” is not used in a restrictive sense, but for explanatory purposes only.

Disclosed herein are components that can be used to perform the herein described methods and systems. These and other components are disclosed herein. It is understood that when combinations, subsets, interactions, groups, etc. of these components are disclosed that while specific reference to each various individual and collective combinations and permutation of these may not be explicitly disclosed, each is specifically contemplated and described herein, for all methods and systems. This applies to all aspects of this specification including, but not limited to, steps in disclosed methods. Thus, if there are a variety of additional steps that can be performed, it is understood that each of the additional steps can be performed with any specific embodiment or combination of embodiments of the disclosed methods and systems.

As will be appreciated by one skilled in the art, the methods and systems may take the form of an entirely new hardware embodiment, an entirely new software embodiment, or an embodiment combining new software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, non-volatile flash memory, CD-ROMs, optical storage devices, and/or magnetic storage devices, and the like. An exemplary computer system is described below.

Embodiments of the methods and systems are described below with reference to block diagrams and flowchart illustrations of methods, systems, apparatuses and computer program products. It will be understood that each block of the block diagrams and flow illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions, and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

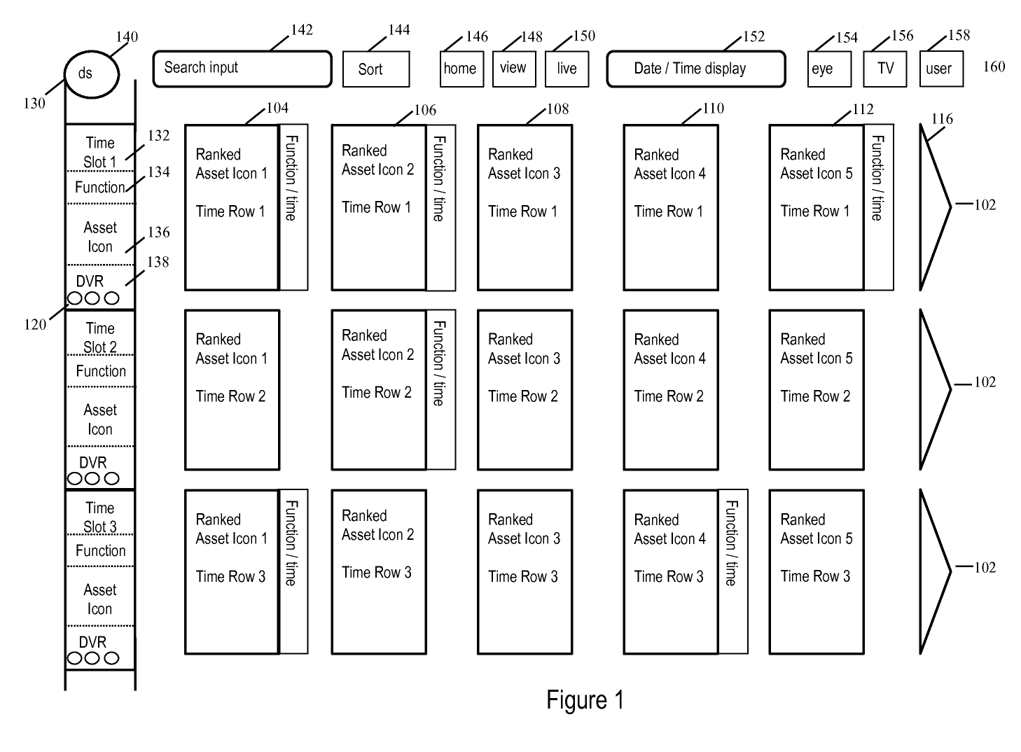

FIG. 1 illustrates an exemplary, interactive display screen 100 in schematic or block format that presents a user (or group of users) with ranked multimedia search results and recommendations according to the teachings disclosed and described herein. The display screen 100 illustrates ranked multimedia search results and recommendations for the user (or group of users) in just one of many possible implementations and arrangements. Preferably, the display screen is fully interactive with each user (or group of users) logged in to use the system. In this particular embodiment or example, the interactive display screen 100 presents a plurality of rows of video assets 102 available for selection in each of a set of time slots, wherein each row represents a different one of the set of time slots. The video or multimedia assets presented in the primary display screen 100 are retrieved from all content source channels accessible by the system and available (based on subscriptions, permissions, etc.) to the user or group of users logged into the system.

In this embodiment, content source channels include, for example, broadcast television providers, cable providers, video available from Internet providers, pay-per-view providers, video on demand (VOD) content providers, and any other content providers for which the user is connected as a subscriber (or is otherwise authorized to access and/or view such content). Each row of video assets 102 is associated with a particular time slot, such as half-hour (or 15 minute or one hour) intervals during the day, and all available and authorized video content from the above content sources is searched for video content available during the time slot associated with the particular row of video assets 102. The search and recommendation engine then determines a ranking order for the presentation of all video assets (104, 106, 108, 110, 112) for each respective time slot to populate each given row of video assets 102. Upon initiation of the system software application, the initial display screen 100 presented to the user populates each row of video assets 102 for each time slot with video assets that meet the recommendation criteria for the user, or group of users for blended recommendation criteria, and ranked for relevance to the particular user or group of users. The video asset for a particular time slot that is recommended for the user or group of users and has the highest relevancy score for the user or group of users is displayed preferably in the leftmost position 104 of the row of video assets 102 and, preferably, is represented by a video representation of video content “cover art” as an icon for the video asset 104. The “cover art” displayed to the user can be a copy of the DVD cover or movie poster (if applicable) associated with the video asset or can be any video screen representation that may be indicative of the content of the video asset. Preferably, the icon is selectable by the user by single or double “clicking” on the icon using the interactive display screen in conventional manner.

The display position immediately to the right of the highest relevancy video asset 104 is populated with cover art representing the video asset 106 with the next highest relevancy score to the user or group of users. This pattern continues for all of the display positions (108, 110, 112) remaining on the display screen 100 and continues to the right to populate virtual display positions (not shown) for any additional video assets that have been discovered for the time slot associated with the row of video assets 102. The virtual display positions are populated in computer memory such that the user may navigate to view additional video assets by selecting or scrolling over the navigate arrow 116 positioned at the rightmost position of the row of video assets 102. Selecting the navigate arrow 116 will move the leftmost video asset 104 icon to the left off the viewable portion of the display screen 100, shift all of the other visible video asset icons (106, 108, 110, 112) one display position to the left in the row, and populate the rightmost visible display position for a video asset 112 with the cover art for the first virtual video asset; thus, allowing the user or group of users to view additional, but lower ranked video asset in the rightmost position 112 in the row of video assets 102. The navigate arrow 116 enables the user or group of users to process or scroll through the list of all recommended video assets for a particular time slot in relevancy ranked order.

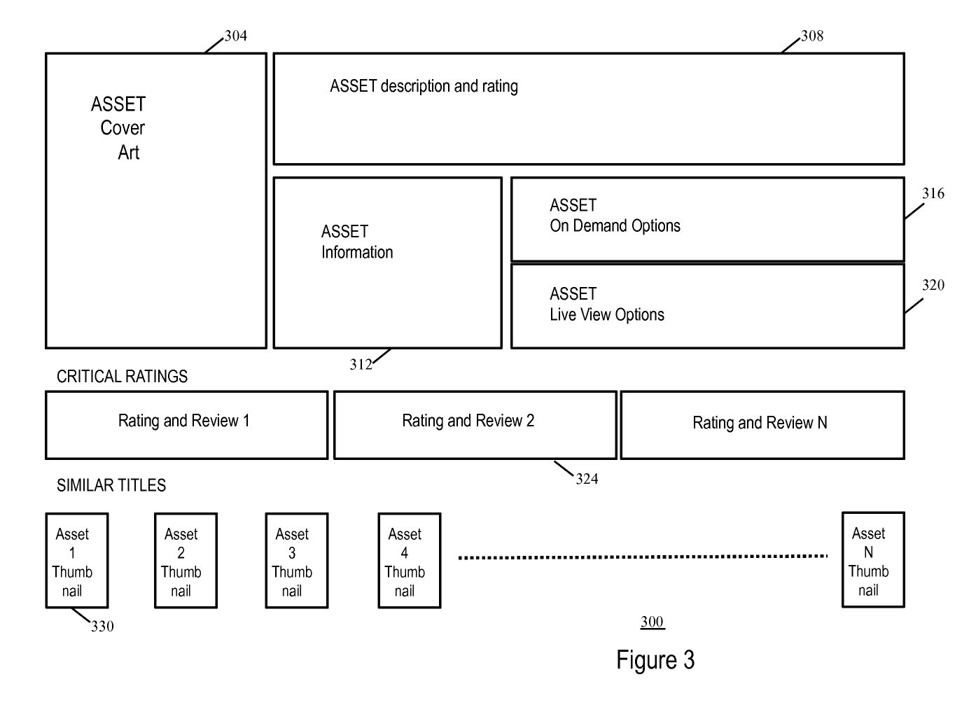

In this embodiment, the user is able to select one or more of the video asset icons 104 displayed in a row of video assets 102. Upon selection, the user may be presented with additional, more highly-detailed information about the video asset, or the user may elect to initiate a function for the selected video asset associated with the selected icon. The presentation of additional detailed information for a selected video asset will be discussed in further detail hereinafter in association with FIG. 3. The user may elect to initiate a function, such as viewing the video content represented by the selected video asset icon 104, or the user may elect to initiate a recording of the video content to one of more attached DVR channels 120. Upon the selection of a video asset 104 and the selection of a function, the display screen preferably attaches an indication of the function and time as a status indicator 124 associated with the video asset 104. By way of example, the video asset 104 has been selected for live viewing in time slot 1 for a duration of 30 minutes and the status indicator 124, which displays the function and time duration, has been appended to video asset 104 indicating this status for the content associated with video asset 104. Additionally, multiple video assets may be selected for functional activity in a single row of video assets 102 for a given time slot. Again, by way of example, the row of video assets 102 for the first displayed time slot indicates that the user has selected video asset 104, video asset 106 and video asset 112 for one of either the live viewing or recording functions and status indicators (such as 124) have been associated with each of the selected video assets to provide current status of each selected video asset to the user.

In this embodiment, a status sidebar 130 is provided to present a current status view for all selected functions associated with each time slot presented in the display. The status sidebar 130 presents a scrollable capsule view of each respective time slot 132, the function chosen for a video asset 134 in that time slot 132, and a thumbnail view 136 of the video asset selected for that respective time slot 132. Additionally, the status sidebar 130 provides the status for any DVR 138 that has been configured for use with the system and an indication of which DVR channels 120 are in use for recording a video asset during the time slot indicated in the status sidebar 130.

The status sidebar 130 is associated with the rows of video assets 102 based upon the time slot associated with each row of video assets 102. By way of example, upon user selection of the video asset 104 within the row of video assets 102, the corresponding portion of the status sidebar 130 based upon the time slot 132 will be populated with the thumbnail 136 for the video asset 104 selected, and the function 134 will be updated to indicate the current status for that timeslot. A current status of “Watch” preferably indicates that the video content is selected for live viewing during that time slot, and a current status of “Record” preferably indicates that the video asset selected for that time slot is being recorded, or may be recorded (if the time slot is in the future). The status sidebar 130 is scrollable under user control and may indicate the current time of day as well as one or more time slots either before or after the current time of day. Each row of video assets 102 is likewise associated with a particular time slot and the screen may display the current time slot and the row of video assets 102 for the current time of day, with additional rows of video assets associated with time slots occurring either before or after the current time of day. The user may scroll the display such that the time slot associated with the current time of day moves either to the top of the display or the bottom of the display such that earlier or later time slots are presented to the user on the display screen. Whatever time slots are displayed to the user on the display screen 100, both the row of video assets and appropriate portion of the status sidebar 130 for the time slots are presented in current view on the display screen.

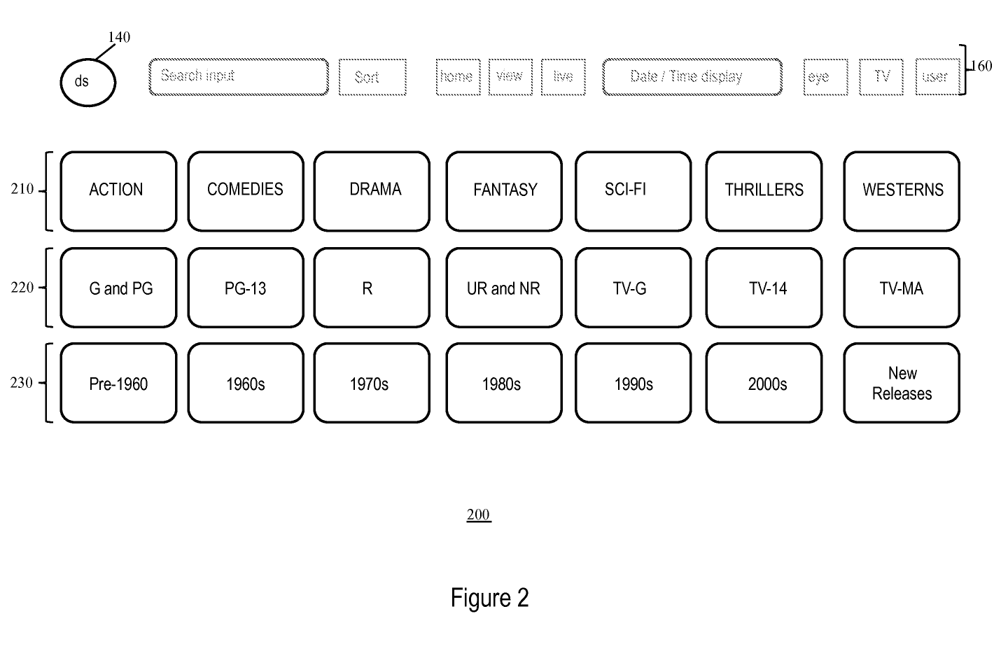

In this exemplary embodiment, the display screen provides status and control icons for user interaction with the search and recommendation system. A menu bar 160 positioned, in this embodiment, at the top of the display screen, above the top row of video assets 102, presents a search filter icon 140 in the leftmost position in the menu bar 160. The search filter icon 140 is a toggle that, when selected, temporarily replaces the video asset display screen 100 with a search filter selection display screen 200. The search filter selection display screen 200 is presented in FIG. 2 and will be described more fully below.

The menu bar 160 may have a search input box 142 to accept user input, which allows a user to input a specific search for desired video content. This type of a search may accept the user input and utilize the input parameters as an additional filter for the preferred content to be ranked and presented to the user for each time slot row in the primary display. Once again, the video content located utilizes the input parameter to direct the search, but the video assets discovered are also ranked and recommended by asset relevancy score associated with the user, or a blended relevancy score associated with a group of users. The video assets discovered continue to be presented on a per time slot basis, populating the time slot rows in ranked order with the video asset having the greatest similarity to the search term input by the user and the highest relevancy ranking in the leftmost video asset position in the time slot row. Other discovered video assets populate positions in the time slot row from left to right in decreasing order of relevance and similarity to the input search term.

The menu bar 160 may also have a search status sort indicator 144 that may present an indication of the type of sort performed to discovery and populate the current display view of video assets. In another non-limiting embodiment, a search status sort indicator 144 displays a status of “predicted rating” when the results populating the display screen have been discovered and sorted according to a predicted rating for the user, or group of users.

The menu bar 160 preferably also has a designated home display icon 146, shown to the right of the search status sort indicator 144, that enables the user to change the display to a “personalized” home landing screen display (not shown). The home landing screen may be customized to an individual user's desired display options, presenting discovered video assets in a preferred display configuration. The user-preferred display configuration preferably provides the user with the ability to display video assets in some combination of time-based, relevancy-based, or recommendation-based sort for ease of navigation according to a user's personal desire.

The menu bar preferably also has a rating and recommendations view icon 148, positioned to the right of the home display icon 146, that presents a screen display for all discovered video assets ranked purely by relevancy and rating, without regard to the time when each video asset is to be presented for viewing. The ratings and recommendation display screen (not shown) presents a variable list of all discovered video assets that meet user input search filters, in addition to the relevancy score and recommendation score for the user, without regard to time order. The video asset icons may be presented in ranked order with the video asset having the highest recommendation, relevancy, and similarity score presented at the top left most position of the screen display. All other discovered video asset icons may be displayed in descending order of ranking, again based upon the combination of the recommendation, relevancy, and similarity scores for each video asset.

The menu bar preferably also has a time-ordered display icon 150, positioned to the right of the ranking and relevancy icon 148 that presents the display view associated with FIG. 1 when selected. A user may choose any of the display icons as the default display screen for the to user when the system is initiated.

The menu bar 160 also preferably has a prominent Date and Time display box 152, positioned to the right of the time-ordered display icon 150. This informational display box presents the user with a prominent view of the current date and time.

The menu bar 160 also preferably has a previously viewed icon 154, positioned to the right of the Date and Time display box 152. The previously viewed icon 154 is implemented as a toggle function that presents the user with a display (not shown) of all of the video asset icons for video assets the user has viewed during a pre-defined time span prior to the current date and time.

The menu bar 160 also preferably has a TV/Video icon 156, positioned to the right of the previously viewed icon 154. The TV/Video icon 156 is implemented as a toggle function that presents the user with the ability to change the view of the video asset icons presented from those video assets classified as movie video assets to those video assets classified as TV video assets and back again. The TV/Video icon 156 provides assistance to the user in navigating discovered video assets by limiting the video assets displayed by their classification of TV or movie video assets.

The menu bar 160 also preferably has a user settings icon 158, positioned to the right of the TV/Video icon 156. The user settings icon 158 is also positioned as the right most icon of the menu bar disclosed in the menu bar of FIG. 1. The user settings icon 158 provides the user with access to a drop down box menu containing control and preferences settings that are accessible to the user to configure and set preferences for the user displays provided by the search and recommendation system. The user settings icon 158 drop down menu may also provide the user with the ability to change location and provider information for use with the system. The user settings display drop down menu is not shown.

FIG. 2 illustrates an exemplary search filter selection display screen 200 in schematic or block format. The search filter icon 140 acts to toggle the display from the video asset display screen 100 to the search filter selection display screen 200 and back. Upon selecting the search filter icon 140 from the video asset display screen 100, the user is presented with the search filter selection display screen 200. In this exemplary embodiment the search filter selection display screen 200 presents the user with rows (210, 220, 230) of filter selections in the form of labeled icons. The topmost row 210 in the video display presents filter icons for the genre of video assets for which the user would like to filter discovered video assets. The next row 220 in the video display presents filter icons that represent the rating associated with video assets for which the user would like to filter results. The ratings may include, for example, ratings assigned by the Motion Picture Association of America (MPAA), the TV Parental Guidelines, or other pre-defined ratings entities. The ratings icons may also include a rating icon that filters specifically for not-rated (NR) or unrated video assets. The next row 230 in the video display presents filter icons that represent the time period in which the video asset was produced or released for public consumption. In this non-limiting example, the filter icons displayed in the time period row 230 applies filters for video assets released prior to 1960, and then for each decade from the 1960s through the 2000s, with an icon for new releases, as well. The user may select none of the filter icons upon reviewing the filters available, or the user may choose to select one or more of the filter icons to associate that filter to the search and present video assets that are filtered in accordance with the selected filters. The more filters the user selects, the more filters are used in the search for video assets and the more restrictive the search for video assets that meet the users criteria.

The search filters presented in the exemplary view of the search filter selection display screen 200 are presented by way of example and not of limitation. The screen may include more rows of filters as additional filters are described for use with the system, or the filter icons in the display may be reconfigured to better represent the sets of filters available for selection and use with the system. Upon selection of the search filter icon 140 on FIG. 2, the user is returned to the video asset display screen 100. The video asset display screen 100 will then be populated with the discovered video assets, re-ordered based upon the user selected filters.

FIG. 3 illustrates an exemplary video asset detailed information screen 300 in schematic or block format. The detailed information screen 300 is displayed to a user whenever the user selects a video asset icon from the video asset display screen 100. The detailed information screen 300 may be superimposed upon the video asset display screen 100, covering only a portion of the screen, or it may be sized to cover the entire available screen area. The detailed information screen 300 may contain a display area 304 in which will be displayed the cover art associated with the video asset selected. Another screen display area 308 adjacent to the asset cover art display area 304 may be populated with the video asset description and rating. The video asset description and rating 308, in a non-limiting example, may consist of the title of the asset, a content rating associated with the video asset, and a brief description of the content of the video asset itself.

Adjacent to both the asset cover art display area 304 and the video asset description and rating display area 308 is a display area 312 in which detailed information about the asset is presented. The detailed asset information may consist of any metadata information about the video asset such as, by way of example, the director, cast members, the genres with which the asset is associated, and any other detailed information that might be of interest to the user. Adjacent to the asset information display area 312 may be display areas that present the user with information concerning asset On Demand options 316 and asset Live View options 320. The asset On Demand display area 316 preferably displays asset and content providers that may present the user with options to purchase content to be downloaded and presented to the user on the video display. In a non-limiting example, On Demand providers such as Hulu®, iTunes®, Netflix®, or any other provider of content for purchase on demand may be presented to the user, along with an option to purchase the content being offered. The asset Live View options display area 320 preferably displays content options that are available from broadcast, cable, or other content providers that present content that is free (or subscribed) to the user. For each content provider listed in the asset Live View options display area 320, the user is preferably given information regarding the provider, date and time information, channel location information, and the option to set up recording for the content being broadcast. Icons 324 enable the user to select and display ratings and reviews associated with the video asset. Thumbnail icons 330 present the user with similar titles that have similar ranking and relevancy to the video asset.

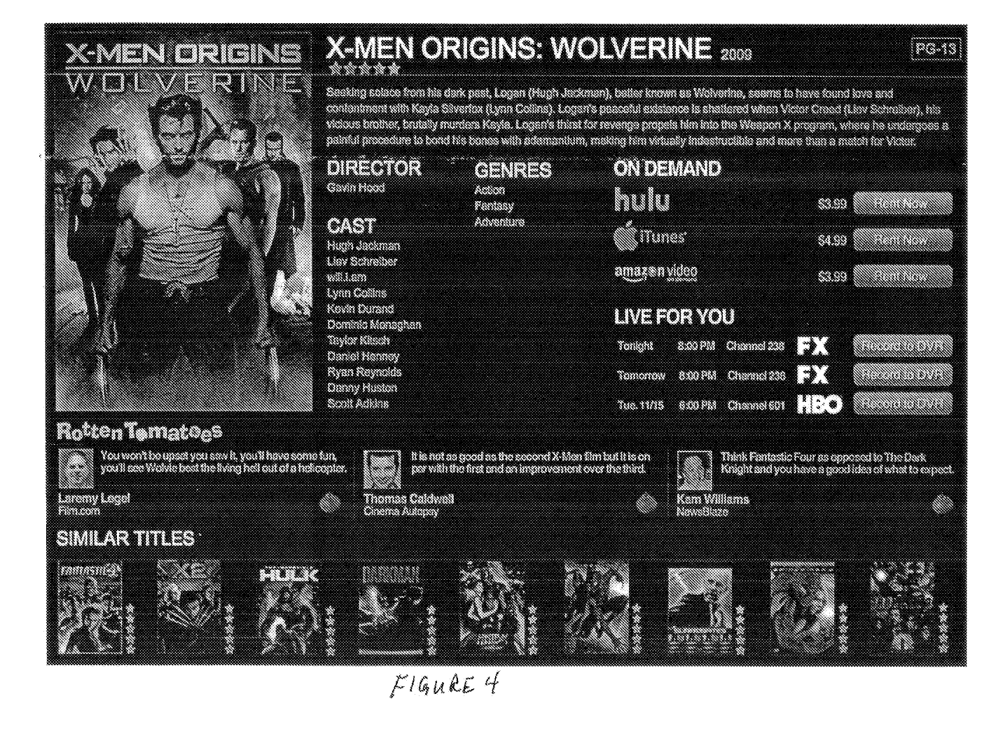

FIG. 4 presents an exemplary screen shot 400 corresponding to the interactive display screen 100 from FIG. 1. This exemplary screen shot is a view of the screen layout that presents at least three rows of cover art icons for ranked video assets discovered from all available video content sources. The screen shot also presents the menu bar across the top of the screen, positioned above the rows of cover art icons. To the left of the rows of cover art icons, the status sidebar is presented, as described previously. The screen shot is presented as an exemplary view of the implementation of the search and recommendation system and should not be considered limiting.

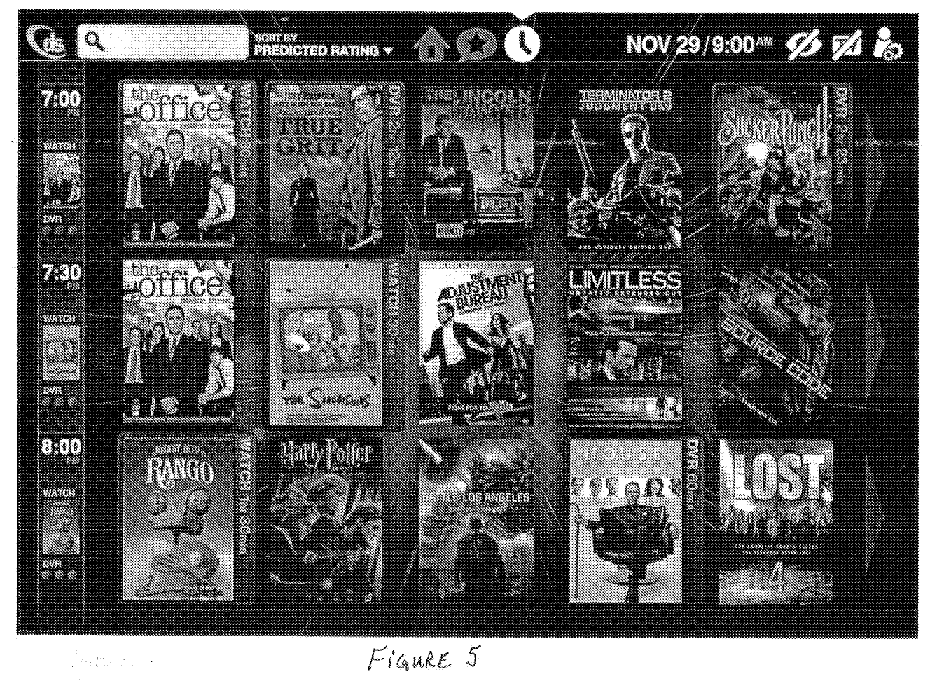

FIG. 5 presents an exemplary screen shot 500 corresponding to the search filter selection display screen 200 from FIG. 2, which displays the search and recommendation filters that may be selected by the user to personalize a search for video assets to be presented to the user. As discussed previously, multiple filter icons may be selected for use in refining and personalizing a search for video assets. The screen shot is presented as an exemplary view of the implementation of the search and recommendation system and should not be considered limiting.

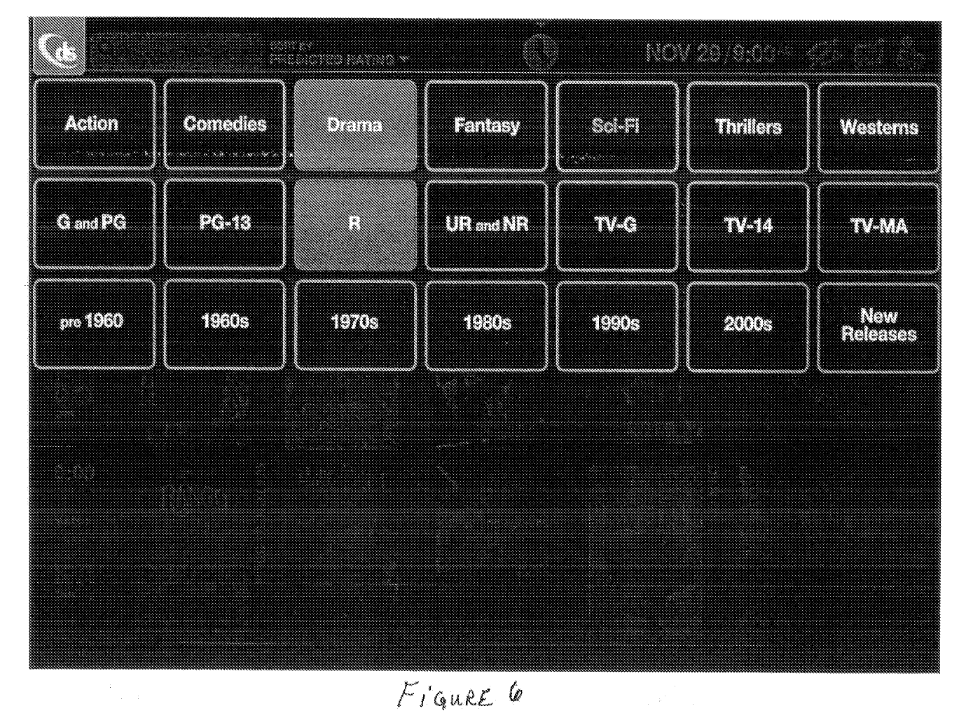

FIG. 6 presents an exemplary screen shot 600 corresponding to the video asset detailed information screen 300 from FIG. 3. This exemplary screen shot is a view of the screen layout for detailed information that is associated with a video asset icon selected on the video asset display screen 100. The screen shot is presented as an exemplary view of the implementation of the search and recommendation system and should not be considered limiting.

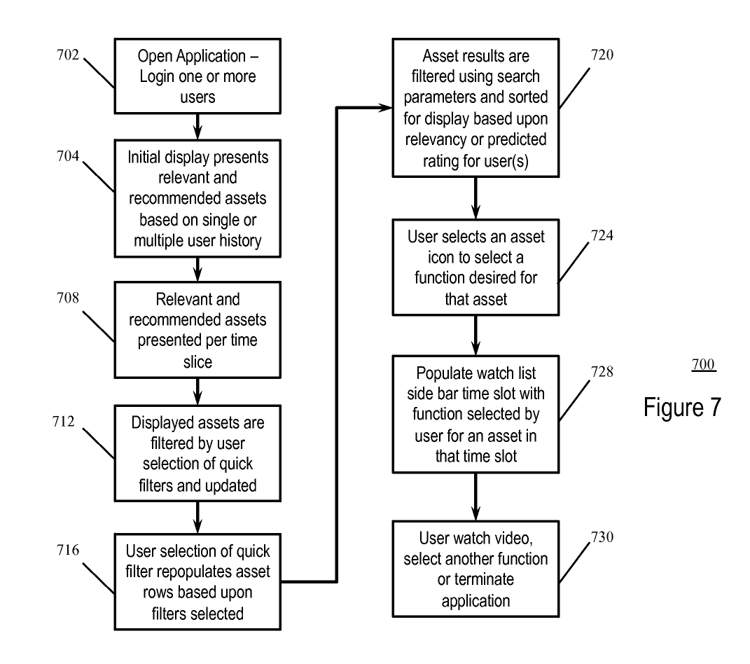

FIG. 7 presents an exemplary flow diagram 700 for video content processing in accordance with the search and recommendation system described herein. In this exemplary implementation, a user, or a member of a group of users, launches the application by selecting the application from a list or group of applications to open the application and logging in one or more users, at step 702. At step 704, the search and recommendation application presents a screen display, such as the video asset display screen 100 from FIG. 1, upon which the initial display of multimedia or video assets are presented, preferably, using visual icons. The visual icons represent relevant and recommended multimedia or video assets relevant to the viewing history of the user who has logged into the system, or, where multiple users are logged in, relevant and recommended multimedia or video assets relevant to the viewing history of the multiple users logged into the system. At step 708, in one exemplary implementation, the relevant and recommended video assets are presented on the screen display in a plurality of rows of cover art video icons in accordance with the time slice or slots (date and time) for which the video assets are available for viewing or recording. In an additional exemplary implementation, the relevant and recommended video assets are further arranged based upon the ranking for relevancy and predicted rating of each video asset. The relevant ranking is preferably calculated as a score including the relevancy score and the predicted rating score for the individual user or group of users logged into the system—based upon or as determined by the login IDs used by the user or group of users, upon initial launch of the application. Depending upon the desired and selected user settings, the presentation of video asset icons in relevancy order may be restricted to specific time slot availability or may ignore time slots availability information and present the video icons based on overall rank and relevancy to the user or group of users.

At step 712, in the exemplary implementation presenting the video asset icons in particular time slice display order, the displayed video assets may be filtered by user selection of quick filters to further refine user preferences for presentation. The personalization of the presentation of video assets may be in accordance with the preferences expressed by the one or more users through the selection of one or more filters for the search and update of the video assets. The selection of filters for the update of the presentation of the video assets available for user viewing may cause an automatic update of the search for relevant video assets of interest to the user, or group of users, and an automatic update of the rows of video asset icons displayed at step 716.

At step 720, the video asset search results may be further filtered using search parameters and sorted for display to the user on the video asset display screen 100 based upon the relevancy or predicted rating for user or group of users. The user then selects a desired video asset by clicking on or otherwise activating the video icon, which then enables the user to select a function desired for that video asset at step 724. Functions available to the user include, for example, immediately watching the selected video asset if the video asset has already been recorded or is otherwise currently available from one or more content providers, requesting that the selected video asset be recorded at a future date and time. Additional functions, such as scheduling future live viewing, adding the video asset to a list of favorites, forwarding a link to the video or forwarding additional information about the video asset to a third party, and the like, choose without departing from the scope of the system functionality.

At step 728, the status sidebar functions as a dynamic watch list for the user or group of users. The watch list may be populated in accordance with the time slots by selecting the function (watch, record, etc.) and the video asset for each time slot available in the watch list. Upon selection of the video asset icon by the user, a thumbnail of the video asset icon may then populate the associated time slot in the status sidebar watch list along with the function requested for the selected video asset. The user may progress through the status sidebar watch list by selecting the watch list and scrolling either forward in time or backward in time to review the selected asset icons and requested function chosen for each selected asset icon in each time slot presented in the status sidebar watch list. In this manner, the user, or group of users, may have an instant update view of all video assets selected previously and the function requested for each selected video asset in a shorthand view of all available discovered and recommended video content. At step 730, the user, or a representative of a group of users, may choose to watch a selected video asset live or previously recorded, may continue to search for additional recommendations and discovered video assets by further filtering the search, may set recording (or other type of function) for one or more discovered and recommended video assets, or may choose to end the application and terminate the search and recommendation system.

It is to be understood that the system and methods, which have been described above are merely illustrative applications of the principles of the invention. Numerous modifications may be made by those skilled in the art without departing from the true spirit and scope of the invention.

In view of the foregoing detailed description of preferred embodiments of the present invention, it readily will be understood by those persons skilled in the art that the present invention is susceptible to broad utility and application. While various aspects have been described in the context of screen shots, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

We claim:

1. A method for presenting multimedia digital content of viewing interest to a user, comprising:
collecting metadata associated with the user;
determining which of the multimedia assets in a collection of multimedia digital content is available to the user based upon metadata associated with each multimedia asset;
ranking the available multimedia assets as a function of the user metadata and of the multimedia asset metadata;
presenting the ranked and available multimedia assets to the user on an interactive display screen;
enabling the user to select one of the ranked multimedia assets, and
presenting the selected ranked multimedia asset to the user for user interaction with the selected ranked multimedia asset.

2. The method of claim 1, where the user may be a single user or a group of users viewing a selected multimedia asset.

3. The method of claim 2, where the determination and presentation of multimedia assets is in response to a query from the user or group of users.

4. The method of claim 1, where ranking the available multimedia assets includes blending ratings data from commercial and social network recommendation sites with information retrieval search results until a pre-determined numerical blend of the search results and ratings data is achieved.

5. The method of claim 1, where the user metadata identifies demographic information about the user and multimedia viewing interests of the user to form a relevancy measure for each multimedia asset in the collection of multimedia digital content.

6. The method of claim 5, where the ranking of multimedia assets is based upon the relevancy measure to form a normalized relevancy score for each multimedia asset in the collection of multimedia digital content.

7. The method of claim 6, where the relevancy measure for each multimedia asset is ranked and recommended for presentation by the normalized asset relevancy score associated with the user, or a blended relevancy score associated with a group of users.

8. The method of claim 1, where a higher ranking of a multimedia asset is indicative of a higher likelihood of viewing interest to a user.

9. The method of claim 7, where higher ranked multimedia assets are featured more prominently when presented to the user on an interactive display screen.

10. The method of claim 1, where user interaction with the selected ranked multimedia asset includes one or more of:
immediate viewing or time-shifted viewing of the selected asset,
recording, purchasing, or renting the selected asset for later access,
communicating the user's interest in the selected digital asset to others via text, email, or postings to social media sites, or
declining the selected asset and selecting an alternative ranked asset for interaction.

11. A system for presenting multimedia digital content of viewing interest to a user, comprising:
a processor adapted for collecting metadata associated with the user;
determining which of the multimedia assets in a collection of multimedia digital content is available to the user based upon metadata associated with each multimedia asset;
ranking the available multimedia assets as a function of the user metadata and of the multimedia asset metadata;
presenting the ranked and available multimedia assets to the user on an interactive display screen;
enabling the user to select one of the ranked multimedia assets, and
presenting the selected ranked multimedia asset to the user for user interaction with the selected ranked multimedia asset.

12. The system of claim 11, where the user may be a single user or a group of users viewing a selected multimedia asset.

13. The system of claim 12, where the processor action for determination and presentation of multimedia assets is in response to a query from the user or group of users

14. The system of claim 11, where the user metadata identifies demographic information about the user and multimedia viewing interests of the user to form a relevancy measure for each multimedia asset in the collection of multimedia digital content.

15. The system of claim 14, where the ranking of multimedia assets is based upon the relevancy measure to form a normalized relevancy score for each multimedia asset in the collection of multimedia digital content.

16. The system of claim 15, where the relevancy measure for each multimedia asset is ranked and recommended for presentation by the normalized asset relevancy score associated with the user, or a blended relevancy score associated with a group of users.

17. The system of claim 11, where a higher ranking of a multimedia asset is indicative of a higher likelihood of viewing interest to a user.

18. The system of claim 17, where higher ranked multimedia assets are featured more prominently when presented to the user on an interactive display screen.

19. The system of claim 11, where user interaction with the selected ranked multimedia asset includes one or more of:
immediate viewing or time-shifted viewing of the selected asset,
recording, purchasing, or renting the selected asset for later access,
communicating the user's interest in the selected digital asset to others via text, email, or postings to social media sites, or
declining the selected asset and selecting an alternative ranked asset for interaction.

20. The system of claim 11, where the initial matching of asset titles is performed as a semantic search through the use of asset-based and time-based metadata associated with content accessible to the system.
